(19) United States
(12) Patent Application Publication
(10) Pub. No.: US 2023/0351896 A1
(43) Pub. Date: Nov. 2, 2023

(54) TRANSPORTATION SERVICE PROVISION WITH A VEHICLE FLEET

(71) Applicant: Uber Technologies, Inc, San Francisco, CA (US)

(72) Inventors: Konstantinos Dean Apostolopoulos, Melbourne (AU); Zelin Liu, Seattle, WA (US); Ryan Kim, San Francisco, CA (US)

(21) Appl. No.: 18/297,933

(22) Filed: Apr. 10, 2023

Related U.S. Application Data
(60) Provisional application No. 63/363,776, filed on Apr. 28, 2022.

(51) Int. Cl. G08G 1/00; G06Q 10/02; G06Q 50/30; G05D 1/02

(52) U.S. Cl. CPC G08G 1/202; G06Q 10/02; G06Q 50/30; G05D 1/0291; G05D 2201/0212; G05D 2201/0213

(57) ABSTRACT

Various examples are directed to systems and methods for managing a mixed fleet of vehicles to execute transportation services. A system may access transportation service request data describing a transportation service requested by a user via a user computing device. The system may determine that the first transportation service is not suitable for execution by at least one of a plurality of autonomous vehicles (AV). The system may prompt the user via the user computing device to make a modification to the transportation service to make it suitable for execution by the at least one of the plurality of AVs.

### BACKGROUND

An autonomous vehicle (AV) is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for managing a mixed fleet of vehicles using a service assignment system.

FIG. 2 depicts a block diagram of an example vehicle according to example aspects of the present disclosure.

FIG. 3 is a flowchart showing one example of a process flow that may be executed to respond to a transportation service request from a user.

FIG. 4 is a flowchart showing one example of a process flow that may be executed by the service assignment system of FIG. 1 to nudge or prompt a user to modify a service request property and/or user preference.

FIG. 5 is a flowchart showing another example of a process flow that may be executed by the service assignment system of FIG. 1 to nudge or prompt a user to modify a service request property and/or user preference.

FIG. 6 is a flowchart showing one example of a process flow that may be executed by the service assignment system of FIG. 1 to filter the mixed fleet of vehicles to determine a set of one or more candidate vehicles.

FIG. 7 is a flowchart showing one example of a process flow that may be executed by the service assignment system of FIG. 1 to filter the mixed fleet of vehicles to determine a set of one or more candidate vehicles using at least one conditional user preference.

FIG. 8 is a block diagram showing one example of a software architecture for a computing device.

FIG. 9 is a block diagram illustrating a computing device hardware architecture.

### DESCRIPTION

Examples described herein are directed to systems and methods for using a computing system to manage and/or operate a mixed fleet of vehicles to execute transportation services, where the mixed fleet includes autonomous vehicles (AVs) and human-operated vehicles.

In an autonomous or semi-autonomous vehicle (collectively referred to as an AV), a vehicle autonomy system, sometimes referred to as an AV stack, controls one or more of braking, steering, or throttle of the vehicle. In a fully autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input. Some autonomous vehicles can also operate in a manual mode, in which a human user provides all control inputs to the vehicle.

In some examples, a service assignment system receives requests for transportation service from one or more users. A transportation service may include transporting a payload, such as cargo and/or one or more passengers, from a service start location to a service end location. Examples of cargo can include food, packages, and/or the like. The service assignment system may match received transportation service requests from users with vehicles from the mixed fleet. When the service assignment system selects a vehicle for a requested transportation service, it may instruct the vehicle to begin executing the requested transportation service.

Managing transportation services in a mixed fleet may present challenges that may not be encountered with other types of fleets. For example, in a mixed fleet setting, the service assignment system may determine whether to assign a requested transportation service to an AV or a human-driven vehicle. Differences in capabilities between AVs and human-driven vehicles may complicate this determination. For example, some transportation service request properties (request properties) and/or preferences of the user (user preferences) may make a requested transportation service unsuitable for AV execution.

For example, AVs and human-operated vehicles may have different capabilities. As a result, some requested transportation services may be suitable for execution by an AV while others may be unsuitable for AV execution. This can lead to additional complications for the service assignment system. For example, upon receiving a transportation service request, the service assignment system may use the request and (optionally) user preferences associated with the requested user to determine whether the requested transportation service is suitable for AV execution. If the requested transportation service is suitable for AV execution, the service assignment system may consider AVs when selecting a vehicle for the transportation service. If the transportation service is unsuitable for AV execution, the service assignment system may exclude AVs from consideration when selecting a vehicle for the transportation service.

The user preferences and/or request properties that affect whether a given transportation service is suitable for AV execution may not always be apparent to users. Some users may desire to have their transportation services executed by an AV. If such a user has a user preference and/or makes requests with request properties that are unsuitable for AV execution, the user may not be assigned an AV and, for that reason, may be dissatisfied with the provided transportation service.

Consider an example user preference related to whether a user is to pick up a payload at the curb and/or have the payload delivered to a door. Transportation services requested by a user with a preference for at-door deliveries may be unsuitable for AV execution at least because an AV may not have a human driver or other mechanism that can transport the payload from the curb to the door. The user may not readily make a connection between the preference for at-door delivery and suitability for AV execution. Consider another example user preference related to how far the user is willing to walk to meet a vehicle at the service start location. In some examples, the pick-up and drop-off locations available to AVs may be more limited than those available to human-driven vehicles. Accordingly, transportation service requests from users with shorter walking distance preferences may be unsuitable for AV execution without the knowledge of the user. Users who wish to have their transportation service executed with an AV but do not due to user preferences or transportation request properties that are not fully understood by the users may have less satisfaction with the provided transportation services.

Other problems with mixed fleet networks may be related to the incorporation of AVs into the mixed fleet. For example, it may be desirable to maximize the number and type of requested transportation services that are suitable for AV execution. This may raise the utilization of the AVs of the mixed fleet, thus increasing their efficiency. Further, making AVs eligible to execute more transportation services may expand the total pool of vehicles that can execute a given transportation service, which can often lead to a lower total cost of executing transportation services.

Also, it may be desirable to increase the acceptance rate of transportation services offered to AVs. When users who might otherwise want or accept an AV-executed transportation service have user preferences or request properties making their requests unsuitable for AV execution, it may reduce the number of transportation services available to be offered to AVs. This may prompt the service assignment system to offer AVs transportation services that the AVs are less likely to accept. Consider an example transportation service having a service start and/or end locations that are in the area covered by an AV, but near the perimeter of that area. The service assignment system may offer the example transportation service for this user to the AV. The AV, however, may be more likely to decline the transportation service than another transportation service with service start and end locations well inside the area covered by the AV.

Accordingly, user preferences and request properties may increase the probability of the AV declining an offered transportation service. When an AV or other vehicle declines an offered transportation service, in some examples, it results in the service assignment system reassigning the transportation service to another vehicle. This may cause the service assignment system to duplicate the work of assigning the transportation service, thereby decreasing the overall efficiency of the service assignment system and potentially reducing the rate at which the service assignment system can process new transportation service requests.

A similar challenge may arise when an AV is assigned to a user who does not desire that their transportation service be executed by an AV. When an AV is assigned to a transportation service for such a user, the user may decline the transportation service, sometimes after arrival of the AV at the service start location. This may lead to inefficiencies at the service assignment system, inefficiencies in the operation of the AV, and/or, in some examples, a lost transportation service opportunity.

These and other challenges may be addressed utilizing a service assignment system that is configured to nudge or otherwise prompt users to modify request properties of a transportation service request and/or user preferences. The user may provide a modification that makes the requested transportation service suitable for AV execution. The service assignment system may then increase the pool of candidate vehicles for the requested transportation service to include AVs and human-driven vehicles.

Also, in some examples, the service assignment system may utilize one or more conditional user preferences. A conditional user preference may be a user preference having an AV state that may be compatible with AV execution and a non-AV state that is less compatible with AV execution. Consider an example conditional user preference related to where a payload is delivered. The service assignment system may support a user preference in which the user prefers to have the payload dropped at an off-street location, such as a door, if the transportation service is executed by a human-driven vehicle (a non-AV state) or the user will meet the vehicle curbside if the transportation service is executed by an AV (an AV state). Consider another example in which a conditional user preference is related to the walking distance. A conditional user preference may have a non-AV state that is a relatively short walking distance and an AV state that is a longer walking distance that the user is willing to accept if a transportation service is to be executed by an AV.

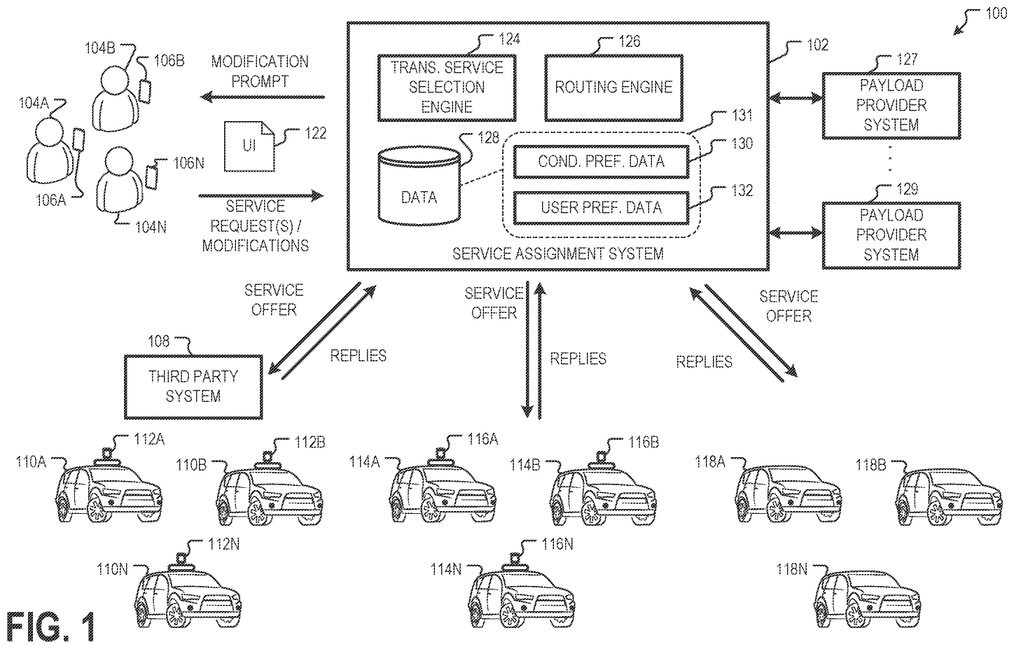

FIG. 1 is a diagram showing one example of an environment 100 for managing a mixed fleet of vehicles using a service assignment system 102. The environment 100 includes the service assignment system 102, a fleet of vehicles 110A, 110B, 110N, 114A, 114B, 114N, 118A, 118B, 118N, and users 104A, 104B, 104N. The fleet of vehicles may be a mixed fleet including AVs and human-driven vehicles. In this example, the fleet includes AVs 110A, 110B, 110N, 114A, 114B, 114N and human-driven vehicles 118A, 118B, 118N. Some or all of the vehicles 110A, 110B, 110N, 114A, 114B, 114N, 118A, 118B, 118N may be passenger vehicles, such as passenger trucks, cars, buses, or other similar vehicles. Also, some or all of the vehicles 110A, 110B, 110N, 114A, 114B, 114N, 118A, 118B, 118N may be delivery vehicles, such as vans, delivery trucks, tractor trailers, etc.

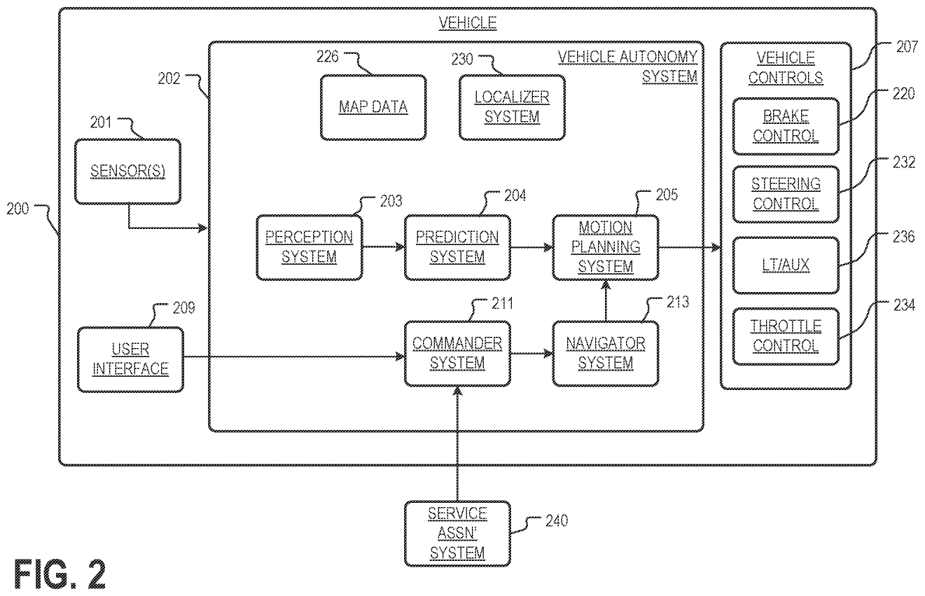

In this example, the AVs 110A, 110B, 110N, 114A, 114B, 114N include respective vehicle autonomy systems, described in more detail with respect to FIG. 2. The vehicle autonomy systems are configured to operate some or all of the controls of the AVs 110A, 110B, 110N, 114A, 114B, 114N (e.g., acceleration, braking, steering). In some examples, one or more of the AVs 110A, 110B, 110N, 114A, 114B, 114N are operable in different modes, where the vehicle autonomy system has differing levels of control over the AV 110A, 110B, 110N, 114A, 114B, 114N. Some AVs 110A, 110B, 110N, 114A, 114B, 114N may be operable in a fully autonomous mode in which the vehicle autonomy system has responsibility for all or most of the controls of the AV 110A, 110B, 110N, 114A, 114B, 114N. Some AVs 110A, 110B, 110N, 114A, 114B, 114N are operable in a semiautonomous mode that is in addition to or instead of the fully autonomous mode. In a semiautonomous mode, the vehicle autonomy system of an AV 110A, 110B, 110N, 114A, 114B, 114N is responsible for some of the vehicle controls while a human user or driver is responsible for other vehicle controls. In some examples, one or more of the AVs 110A, 110B, 110N, 114A, 114B, 114N are operable in a manual mode in which the human user is responsible for all controls of the AV 110A, 110B, 110N, 114A, 114B, 114N.

The AVs 110A, 110B, 110N, 114A, 114B, 114N include one or more respective remote-detection sensor sets 112A, 112B, 112N, 116A, 116B, 116N. The remote-detection sensor sets 112A, 112B, 112N, 116A, 116B, 116N include one or more remote-detection sensors that receive signals from the environment 100. The signals may be emitted by and/or reflected from objects in the environment 100, such as the ground, buildings, trees, etc. The remote-detection sensor sets 112A, 112B, 112N, 116A, 116B, 116N may include one or more active sensors, such as light imaging detection and ranging (LIDAR) sensors, radio detection and ranging (RADAR) sensors, and/or sound navigation and ranging (SONAR) sensors, that emit sound or electromagnetic radiation in the form of light or radio waves to generate return signals. Information about the environment 100 is extracted from the received signals. In some examples, the remote-detection sensor sets 112A, 112B, 112N, 116A, 116B, 116N include one or more passive sensors that receive signals that originated from other sources of sound or electromagnetic radiation. The remote-detection sensor sets 112A, 112B, 112N, 116A, 116B, 116N provide remote-detection sensor data that describes the environment 100. The AVs 110A, 110B, 110N, 114A, 114B, 114N can also include other types of sensors, for example, as described in more detail with respect to FIG. 2.

In some examples, the AVs 110A, 110B, 110N, 114A, 114B, 114N are of different types. Different types of AVs may have different capabilities. For example, the different types of AVs 110A, 110B, 110N, 114A, 114B, 114N can have different vehicle autonomy systems. This can include, for example, vehicle autonomy systems made by different manufacturers or designers, vehicle autonomy systems having different software versions or revisions, etc. Also, in some examples, the different types of AVs 110A, 110B, 110N, 114A, 114B, 114N can have different remote-detection sensor sets 112A, 112B, 112N, 116A, 116B, 116N. For example, one type of AV 110A, 110B, 110N, 114A, 114B, 114N may include a LIDAR remote-detection sensor, while another type may include stereoscopic cameras and omit a LIDAR remote-detection sensor. In some examples, different types of AVs 110A, 110B, 110N, 114A, 114B, 114N can also have different mechanical particulars. For example, one type of vehicle may have all-wheel drive, while another type may have front-wheel drive, etc.

In the example of FIG. 1, the AVs 110A, 110B, 110N are managed by a third-party system 108. The third-party system 108 may be implemented by an entity that manages or otherwise operates the AVs 110A, 110B, 110N. For example, service offers offering a transportation service to the AVs 110A, 110B, 110N may be directed from the service assignment system 102 to the third-party system 108. The third-party system 108 may communicate the service offers to the respective AVs 110A, 110B, 110N. Replies to service offers (e.g., messages accepting and/or declining an offered transportation service) may be sent from the third-party system 108 to the service assignment system 102. In some examples, the third-party system 108 may accept and/or decline a service offer on behalf of the AVs 110A, 110B, 110N. Although one third-party system 108 and associated AVs 110A, 110B, 110N are shown in FIG. 1, it will be appreciated that other examples of the environment 100 may include multiple third-party systems and associated AVs.

In some examples, the service assignment system 102 may communicate directly with AVs 114A, 114B, 114N (e.g., not through a third-party system 108). For example, the service assignment system 102 may provide service offers and receive replies directly to AVs 114A, 114B, 114N.

The AVs 114A, 114B, 114N with which the service assignment system 102 communicates directly may be operated and/or managed by a third-party and/or by the entity implementing the service assignment system 102.

In the example of FIG. 1, the service assignment system 102 also communicates with human-driven vehicles 118A, 118B, 118N, for example, to provide service offers and receive replies. The service assignment system 102 may communicate with the vehicles 118A, 118B, 118N themselves (e.g., through an infotainment system or other suitable computing system of the vehicle) and/or with one or more of the human drivers of the vehicles 118A, 118B, 118N (e.g., via a user computing device or devices of the human drivers). It will be appreciated that FIG. 1 shows just one example of a mixed fleet and that different mixed fleets may have different numbers and proportions of AVs and human-driven vehicles.

The service assignment system 102 is programmed to receive service requests from the users 104A, 104B, 104N and offer requested transportation services to vehicles selected from the fleet of vehicles 110A, 110B, 110N, 114A, 114B, 114N, 118A, 118B, 118N as described herein. The service assignment system 102 can be or include one or more servers or other suitable computing devices. The service assignment system 102 is configured to receive transportation service requests from one or more users 104A, 104B, 104N. The users 104A, 104B, 104N make transportation service requests with user computing devices 106A, 106B, 106N. The user computing devices 106A, 106B, 106N can be or include any suitable computing device such as, for example, tablet computers, mobile telephone devices, laptop computers, desktop computers, etc. In some examples, the user computing devices 106A, 106B, 106N execute an application associated with a transportation service implemented with the service assignment system 102. The users 104A, 104B, 104N launch the application on the respective user computing devices 106A, 106B, 106N and utilize functionality of the application to make transportation service requests.

The service assignment system 102 comprises a transportation service selection engine 124 and a data store 128 storing transportation service data 131. The service assignment system 102 may optionally include a routing engine 126, described in more detail herein.

The transportation service selection engine 124 is programmed to receive and process transportation service requests from users 104A, 104B, 104N. Upon receiving a transportation service request, the transportation service selection engine 124 may filter the fleet of vehicles 110A, 110B, 110N, 114A, 114B, 114N, 118A, 118B, 118N to select a set of one or more candidate vehicles. The candidate vehicles may include vehicles that are suitable, or potentially suitable, for executing the requested transportation service. From the set of candidate vehicles, the transportation service selection engine 124 may select a vehicle or vehicles to which the requested transportation service will be offered. The transportation service selection engine 124 may select the vehicle or vehicles based on any suitable criterion or criteria such as, for example, vehicle locations, vehicle cost to execute the requested transportation service, a prior acceptance rate of the vehicle and/or of vehicles of the same time, etc. In some examples, the transportation service selection engine 124 selects a vehicle or vehicles to offer a transportation service using a route for the transportation service, as generated by the routing engine 126.

The transportation service selection engine 124 may select the candidate vehicles based on various criteria such as, for example, the availability of the various vehicles in the fleet, properties of the service request, and/or user preference data 132. Properties of the service request may include, for example, the service start location, the service end location, the type of payload (e.g., size and weight of payload, number of passengers, etc.).

User preference data 132 may be stored with the transportation service data 131 at the data store 128. The user preference data 132 may describe user preferences related to the provision of transportation services. The specific type of user preference data 132 associated with a user 104A, 104B, 104N may be related to the type of transportation service being requested. Consider an example in which the payload for a transportation service is the user 104A, 104B, 104N him or herself. User preferences may include, for example, a threshold walking distance that the user 104A, 104B, 104N is willing to walk to meet a vehicle, a type of service that the user 104A, 104B, 104N desires, whether the user 104A, 104B, 104N is willing to carpool, whether the user meets the vehicle at the curb or at the user's door, etc. Consider another example in which the payload for a transportation service is a delivery from a restaurant or other store. In this example, user preferences described by user preference data 132 may include, for example, whether user 104A, 104B, 104N will pick-up the delivered payload at the door or at the curb, whether the payload will be left at the door or whether the courier (e.g., human driver of the vehicle) will ring the doorbell, and the like. In some examples, user preferences described by user preference data 132 are location-dependent. For example, a user 104A, 104B, 104N may have one set of preferences for a first location (e.g., deliveries to the user's home) and another set of preferences for a different location (e.g., deliveries to the user's place of work or a friend's house). In another example, a user 104A, 104B, 104N requesting transportation services that involve the user him or herself as payload may have different user preferences for different trip locations (e.g., different cities, different service start locations or service end locations and/or the like).

In some examples, the transportation service selection engine 124 utilizes the routing engine 126 to select a vehicle for offering a transportation service. The routing engine 126 may generate one or more routes for a requested transportation service. In some examples, the transportation service selection engine 124 provides an indication of the set of one or more candidate vehicles to the routing engine 126. The routing engine 126 generates proposed routes for some or all of the set of the candidate vehicles. The proposed routes may begin at the location of a candidate vehicle and extend to the transportation service start position and transportation service end position. If the transportation service includes one or more waypoints, the proposed routes may also pass these waypoints.

The routing engine 126 may generate routes in any suitable manner. In some examples, the routing engine 126 utilizes a routing graph. The routing graph may be a representation of the roadways in a geographic area. The routing graph represents the roadways as a set of graph elements. A graph element is a component of a routing graph that represents a roadway element on which the autonomous vehicle can travel. A graph element can be or include an edge, node, or other component of a routing graph. A graph element represents a portion of roadway, referred to herein as a roadway element. A roadway element is a component of a roadway that can be traversed by a vehicle.

A roadway element can be or include different subdivisions of a roadway, depending on the implementation. In some examples, the roadway elements are or include road segments. A road segment is a portion of roadway including all lanes and directions of travel. Consider a four-lane divided highway. A road segment of the four-lane divided highway includes a stretch of the highway including all four lanes and both directions of travel.

In some examples, roadway elements are or include directed road segments. A directed road segment is a portion of roadway where traffic travels in a common direction. Referring again to the four-lane divided highway example, a stretch of the highway can include at least two directed road segments: a first directed road segment including the two lanes of travel in one direction and a second directed road segment including the two lanes of travel in the other direction.

In some examples, roadway elements are or include lane segments. A lane segment is a portion of a roadway including one lane of travel in one direction. Referring again to the four-lane divided highway example, a portion of the divided highway may include two lane segments in each direction. Lane segments may be interconnected in the direction of travel and laterally. For example, a vehicle traversing a lane segment may travel in the direction to travel to the next connected lane segment or may make a lane change to move laterally to a different lane segment.

In some examples, the service assignment system 102 (e.g., the transportation service selection engine 124 thereof), provides a user interface 122 to the users 104A, 104B, 104N via the respective user computing devices 106A, 106B, 106N. The UI 122 may provide functionality allowing the users to make service requests for transportation services. For example, the UI 122 may include fields in which a user 104A, 104B, 104N can provide request properties such as, for example, a service start location, a service end location, a description of the desired payload, and/or the like.

In some examples, a user 104A, 104B, 104N may request a transportation service that involves the delivery of a product, where the product is all or part of the payload of the transportation service. For example, a user 104A, 104B, 104N may request delivery of a meal from a restaurant or other provider, a delivery of a purchase from a store or other provider. In some examples, the service assignment system 102 is in communication with one or more payload provider systems 127, 129. Payload provider systems 127, 129 are associated with restaurants, stores, or other entities that provide payloads for transportation services, for example, where the payloads are delivered to the service end location.

In some examples, the UI 122 includes information about payload that can be provided by a payload provider system 127, 129. Consider an example in which a transportation service is to deliver prepared food via a payload provider system 127, 129. The UI 122 may include fields allowing the user 104A, 104B to select the payload provider system 127, 129 and/or items from the menu of the payload provider system 127, 129 for delivery. The properties of the service request, then, can include the identified payload. When a vehicle accepts the requested transportation service, the service assignment system 102 may provide an instruction to the selected payload provider system 127, 129 requesting preparation of the payload and providing information about the vehicle that will pick up the payload for delivery.

In some examples, as described herein, the service assignment system 102 (e.g., the transportation service selection engine 124 thereof) may be programmed to nudge users 104A, 104B, 104N by prompting the users 104A, 104B, 104N to modify their user preferences that may prevent the users 104A, 104B, 104N from having requested transportation services executed by AVs. As described herein, this may increase user satisfaction and, in some examples, may increase the utilization of the fleet as a whole and of AVs 110A, 110B, 110N, 114A, 114B, 114N in particular. Also, in some examples, the service assignment system 102 (e.g., the transportation service selection engine 124 thereof) may utilize conditional preferences, described by conditional preference data 130, to select candidate vehicles for a transportation service.

FIG. 2 depicts a block diagram of an example vehicle 200 according to example aspects of the present disclosure. The vehicle 200 shows one example arrangement of the AVs 110A, 110B, 110N, 114A, 114B, 114N of FIG. 1. The vehicle 200 includes one or more sensors 201, a vehicle autonomy system 202, and one or more vehicle controls 207. The vehicle 200 is an autonomous vehicle, as described herein. The example vehicle 200 shows just one example arrangement of an autonomous vehicle. In some examples, autonomous vehicles of different types can have different arrangements.

The vehicle autonomy system 202 includes a commander system 211, a navigator system 213, a perception system 203, a prediction system 204, a motion planning system 205, and a localizer system 230 that cooperate to perceive the surrounding environment of the vehicle 200 and determine a motion plan for controlling the motion of the vehicle 200 accordingly.

The vehicle autonomy system 202 is engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate route through the environment. The vehicle autonomy system 202 sends commands to control the one or more vehicle controls 207 to operate the vehicle 200 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data includes information that describes the location of objects within the surrounding environment of the vehicle 200, information that describes the motion of the vehicle 200, etc.

The sensors 201 may also include one or more remote-detection sensors or sensor systems, such as a LIDAR system, a RADAR system, one or more cameras, etc. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system measures distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system reflect off an object and return to a receiver of the RADAR system, giving information about the object's location and speed. Thus, a RADAR system provides useful information about the current speed of an object.

As yet another example, one or more cameras of the one or more sensors 201 may generate sensor data (e.g., remote-detection sensor data) including still or moving images. Various processing techniques (e.g., range imaging techniques such as structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system determines a current position of the vehicle 200. The positioning system can be any device or circuitry for analyzing the position of the vehicle 200. For example, the positioning system can determine a position by using one or more of inertial sensors, a satellite positioning system such as the Global Positioning System (GPS), a positioning system based on IP address, triangulation and/or proximity to network access points or other network components (e.g., cellular towers, Wi-Fi access points), and/or other suitable techniques. The position of the vehicle 200 can be used by various systems of the vehicle autonomy system 202.

Thus, the one or more sensors 201 are used to collect sensor data that includes information that describes the location (e.g., in three-dimensional space relative to the vehicle 200) of points that correspond to objects within the surrounding environment of the vehicle 200. In some implementations, the sensors 201 can be positioned at different locations on the vehicle 200. As an example, in some implementations, one or more cameras and/or LIDAR sensors can be located in a pod or other structure that is mounted on a roof of the vehicle 200, while one or more RADAR sensors can be located in or behind the front and/or rear bumper(s) or body panel(s) of the vehicle 200. As another example, one or more cameras can be located at the front or rear bumper(s) of the vehicle 200. Other locations can be used as well.

The localizer system 230 receives some or all of the sensor data from the sensors 201 and generates vehicle poses for the vehicle 200. A vehicle pose describes a position and attitude of the vehicle 200. The vehicle pose (or portions thereof) can be used by various other components of the vehicle autonomy system 202 including, for example, the perception system 203, the prediction system 204, the motion planning system 205, and the navigator system 213.

The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates vehicle poses by comparing sensor data (e.g., remote-detection sensor data) to map data 226 describing the surrounding environment of the vehicle 200.

In some examples, the localizer system 230 includes one or more pose estimators and a pose filter. Pose estimators generate pose estimates by comparing remote-detection sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 are provided to various other components of the vehicle autonomy system 202. For example, the commander system 211 may utilize a vehicle position to determine whether to respond to a call from a service assignment system 240.

The commander system 211 determines a set of one or more target locations that are used for routing the vehicle 200. The target locations are determined based on user input received via a user interface 209 of the vehicle 200. The user interface 209 may include and/or use any suitable input/output device or devices. In some examples, the commander system 211 determines the one or more target locations considering data received from the service assignment system 240. The service assignment system 240 is programmed to provide instructions to multiple vehicles, for example, as part of a fleet of vehicles for moving passengers and/or cargo. Data from the service assignment system 240 can be provided via a wireless network, for example.

The navigator system 213 receives one or more target locations from the commander system 211 and map data 226. The map data 226, for example, provides detailed information about the surrounding environment of the vehicle 200. The map data 226 provides information regarding identity and location of different roadways and roadway elements. A roadway is a place where the vehicle 200 can drive and may include, for example, a road, a street, a highway, a lane, a parking lot, or a driveway. Routing graph data is a type of map data 226.

From the one or more target locations and the map data 226, the navigator system 213 generates route data describing a route for the vehicle 200 to take to arrive at the one or more target locations. In some implementations, the navigator system 213 determines route data using one or more path-planning algorithms based on costs for graph elements/corresponding roadway elements, as described herein. For example, a cost for a route can indicate a time of travel, risk of danger, or other factor associated with adhering to a particular proposed route. Route data describing a route is provided to the motion planning system 205, which commands the vehicle controls 207 to implement the route or route extension, as described herein. The navigator system 213 can generate routes as described herein using a general-purpose routing graph and routing graph modification data. Also, in examples where route data is received from the service assignment system 240, that route data can also be provided to the motion planning system 205.

The perception system 203 detects objects in the surrounding environment of the vehicle 200 based on sensor 201 data, the map data 226, and/or vehicle poses provided by the localizer system 230. For example, the map data 226 used by the perception system 203 describes roadways and segments thereof and may also describe buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 200. State data describes a current state of an object (also referred to as features of the object). The state data for each object describes, for example, an estimate of the object's current location (also referred to as position); current speed (also referred to as velocity); current acceleration; current heading; current orientation; size/shape/footprint (e.g., as represented by a bounding shape such as a bounding polygon or polyhedron); type/class (e.g., vehicle, pedestrian, bicycle, or other); yaw rate; distance from the vehicle 200; minimum path to interaction with the vehicle 200; minimum time duration to interaction with the vehicle 200; and/or other state information.

In some implementations, the perception system 203 determines state data for each object over a number of iterations. In particular, the perception system 203 updates the state data for each object at each iteration. Thus, the perception system 203 detects and tracks objects, such as other vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 generates prediction data associated with one or more of the objects detected by the perception system 203. In some examples, the prediction system 204 generates prediction data describing each of the respective objects detected by the perception system 203.

Prediction data for an object is indicative of one or more predicted future locations of the object. For example, the prediction system 204 may predict where the object will be located within the next 5 seconds, 30 seconds, 200 seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left turn for the vehicle such that the vehicle turns left at the intersection. Similarly, the prediction system 204 determines predicted trajectories for other objects, such as bicycles, pedestrians, parked vehicles, etc. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object, and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 commands the vehicle controls 207 based at least in part on the predicted trajectories associated with the objects within the surrounding environment of the vehicle 200, the state data for the objects provided by the perception system 203, vehicle poses provided by the localizer system 230, the map data 226, and route or route extension data provided by the navigator system 213. Stated differently, given information about the current locations of objects and/or predicted trajectories of objects within the surrounding environment of the vehicle 200, the motion planning system 205 determines control commands for the vehicle 200 that best navigate the vehicle 200 along the route or route extension relative to the objects at such locations and their predicted trajectories on acceptable roadways.

In some implementations, the motion planning system 205 can also evaluate one or more cost functions and/or one or more reward functions for each of one or more candidate control commands or sets of control commands for the vehicle 200. Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate control command or set of control commands. The motion planning system 205 can select or determine a control command or set of control commands for the vehicle 200 based at least in part on the cost function(s) and the reward function(s). For example, the motion plan that minimizes the total cost can be selected or otherwise determined.

In some implementations, the motion planning system 205 can be configured to iteratively update the route or route extension for the vehicle 200 as new sensor data is obtained from the one or more sensors 201. For example, as new sensor data is obtained from the one or more sensors 201, the sensor data can be analyzed by the perception system 203, the prediction system 204, and the motion planning system 205 to determine the motion plan.

The motion planning system 205 can provide control commands to the one or more vehicle controls 207. For example, the one or more vehicle controls 207 can include throttle systems, brake systems, steering systems, and other control systems, each of which can include various vehicle controls (e.g., actuators or other devices that control gas flow, steering, and braking) to control the motion of the vehicle 200. The various vehicle controls 207 can include one or more controllers, control devices, motors, and/or processors.

The vehicle controls 207 include a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 200. The secondary system may be configured to determine a failure of the primary system to brake the vehicle 200 in response to receiving the braking command.

A steering control system 232 is configured to receive a steering command and bring about a response in the steering mechanism of the vehicle 200. The steering command is provided to a steering system to provide a steering input to steer the vehicle 200.

A lighting/auxiliary control module 236 receives a lighting or auxiliary command. In response, the lighting/auxiliary control module 236 controls a lighting and/or auxiliary system of the vehicle 200. Controlling a lighting system may include, for example, turning on, turning off, or otherwise modulating headlights, parking lights, running lights, etc. Controlling an auxiliary system may include, for example, modulating windshield wipers, a defroster, etc.

A throttle control system 234 is configured to receive a throttle command and bring about a response in the engine speed or other throttle mechanism of the vehicle. For example, the throttle control system 234 can instruct an engine and/or engine controller, or other propulsion system component, to control the engine or other propulsion system of the vehicle 200 to accelerate, decelerate, or remain at its current speed.

Each of the perception system 203, the prediction system 204, the motion planning system 205, the commander system 211, the navigator system 213, and the localizer system 230 can be included in or otherwise be a part of the vehicle autonomy system 202 configured to control the vehicle 200 based at least in part on data obtained from the one or more sensors 201. For example, data obtained by the one or more sensors 201 can be analyzed by each of the perception system 203, the prediction system 204, and the motion planning system 205 in a consecutive fashion in order to control the vehicle 200. While FIG. 2 depicts elements suitable for use in a vehicle autonomy system according to example aspects of the present disclosure, one of ordinary skill in the art will recognize that other vehicle autonomy systems can be configured to control an autonomous vehicle based on sensor data.

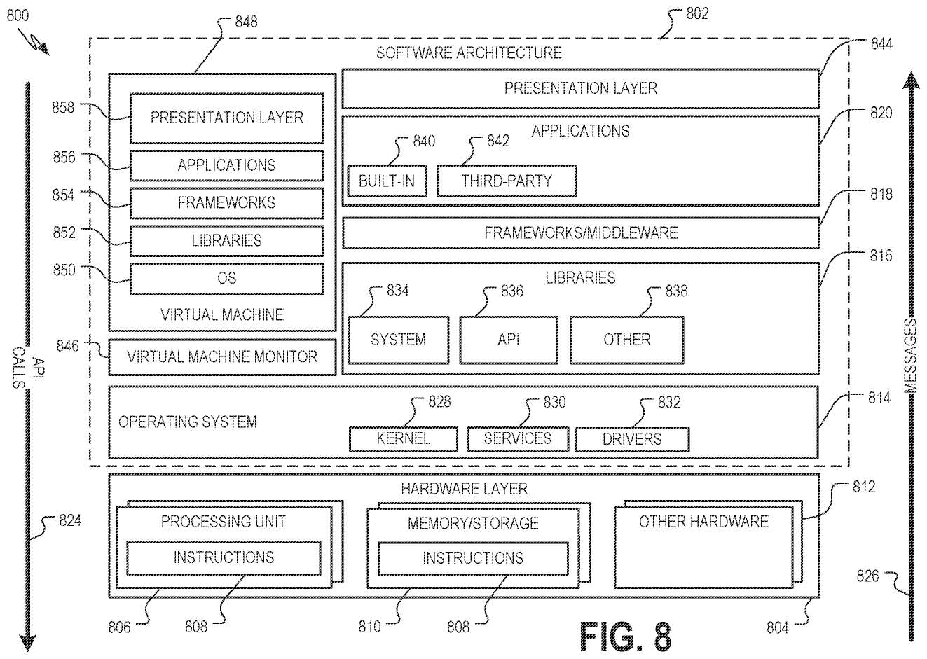

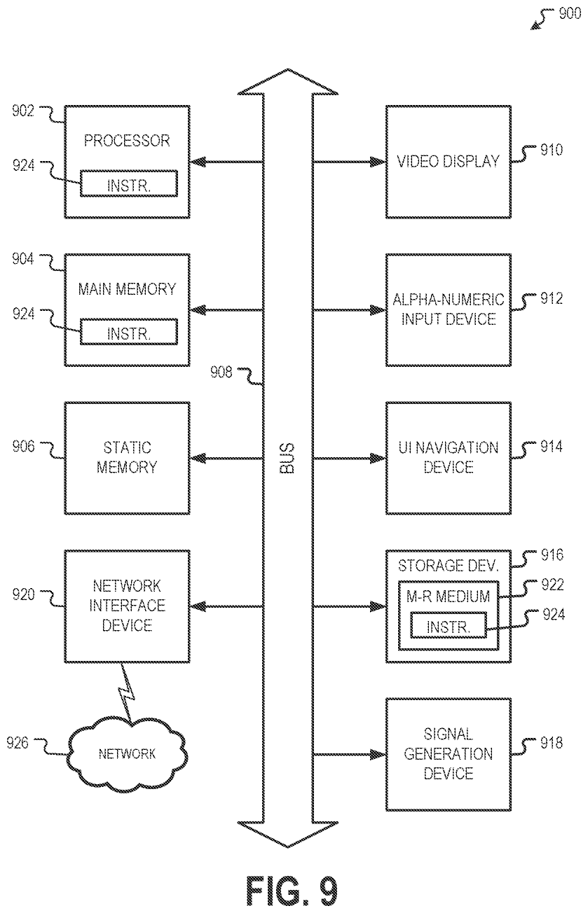

The vehicle autonomy system 202 includes one or more computing devices, which may implement all or parts of the perception system 203, the prediction system 204, the motion planning system 205, and/or the localizer system 230. Descriptions of hardware and software configurations for computing devices to implement the vehicle autonomy system 202 and/or the service assignment system 102 of FIG. 1 are provided herein with reference to FIGS. 8 and 9.

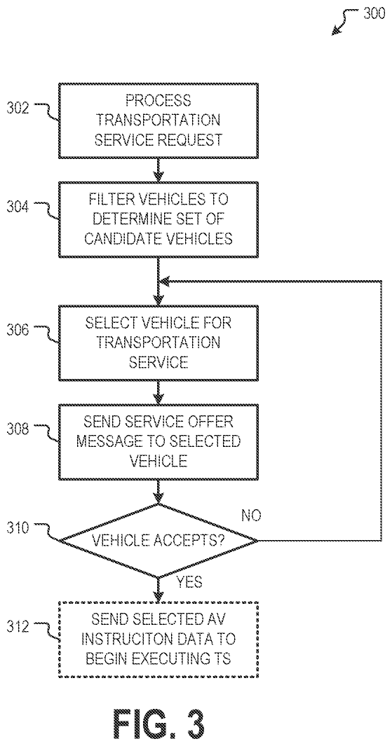

FIG. 3 is a flowchart showing one example of a process flow 300 that may be executed by the service assignment system 102 (e.g., the transportation service selection engine 124 thereof) to respond to a transportation service request from a user 104A, 104B, 104N.

At operation 302, the service assignment system 102 processes a transportation service request received from a user 104A, 104B, 104N. For example, the transportation service request may be received by the service assignment system 102 via the UI 122. The transportation service request may include request properties describing the requested transportation service. The request properties may include, for example, the service start location, the service end location, a type of payload, and/or the like. Processing the transportation service request, in some examples, includes prompting the requesting user 104A, 104B, 104N to modify a request property and/or user preference, for example, to make the requested transportation service more suitable for execution by an AV. In some examples, processing the transportation service request may also include generating one or more transportation service descriptions that may be used to filter the vehicles of the fleet, as described herein.

At operation 304, the service assignment system 102 may filter vehicles from the fleet of vehicles 110A, 110B, 110N, 114A, 114B, 114N, 118A, 118B, 118N to select a set of one or more vehicles that are candidate vehicles. The set of candidate vehicles may include vehicles that are suitable for executing the requested transportation service. The set of candidate vehicles, in some examples, is selected using the request properties of the transportation service request and/or user preference data 132. In some examples, the set of candidate vehicles may be selected using conditional preference data 130, as described herein.

At operation 306, the service assignment system 102 may select a vehicle from the set of candidate vehicles to be offered the transportation service. The selected vehicle may be determined in any suitable manner. In some examples, the service assignment system 102 uses the routing engine 126 to generate a proposed route for each vehicle of the set of one or more candidate vehicles. The cost of the routes for the candidate vehicles may be considered when selecting the vehicle. For example, a vehicle having a lower-cost route to execute a transportation service may be favored over another vehicle having a higher cost. In some examples, other factors may also be considered when selecting the vehicle such as, for example, a previous acceptance rate of the candidate vehicle and/or vehicles similar to the candidate vehicle.

At operation 308, the service assignment system 102 sends a service offer message to the selected candidate vehicle. The offer message may include a description of the requested transportation service. In some examples, the offer message also includes an instruction to begin executing the requested transportation service. The instruction may be provided directly to the vehicle and/or to a human or other entity associated with the vehicle. For example, an instruction to a human-driven vehicle may be provided to the human that is driving the vehicle. An instruction to an AV may be provided directly to the vehicle and/or to a third-party system 108 associated with the AV.

The selected candidate vehicle may accept or decline the requested transportation service. If the selected candidate vehicle declines the requested transportation service, it may send a reply message to the service assignment system 102 declining the service. If the selected candidate vehicle accepts the requested transportation service, it may send a reply message to the service assignment system 102 accepting the transportation service and/or begin executing the transportation service.

At operation 310, the service assignment system 102 determines whether the selected candidate vehicle has accepted the requested transportation service, for example, based on one or more reply messages received from the selected candidate vehicle. If the selected candidate vehicle has declined the requested transportation service, the service assignment system 102 may return to operation 306 and determine a new selected candidate vehicle to which the requested transportation service will be offered. If the selected candidate vehicle accepts the requested transportation service, the service assignment system 102 may end the process flow 300.

In some examples, the service assignment system 102 may, at optional operation 312, send an instruction, for example, to the selected candidate vehicle. The instruction may indicate that the selected candidate vehicle begin executing the requested transportation service. For example, in some examples, the service offer message may not include the instruction to begin executing the requested transportation service. The selected candidate vehicle may indicate acceptance of the requested transportation service by sending a reply message to the service assignment system 102 and may not begin executing the requested transportation service until receiving the instruction sent at optional operation 312.

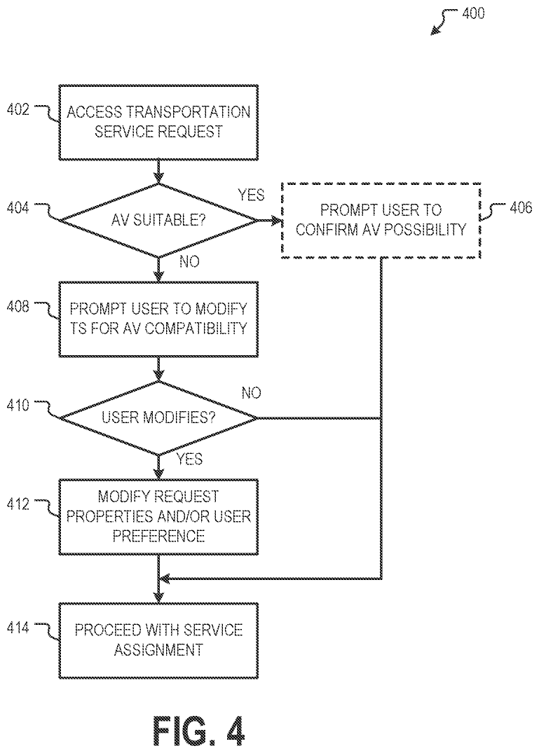

FIG. 4 is a flowchart showing one example of a process flow 400 that may be executed by the service assignment system 102 (e.g., the transportation service selection engine 124 thereof) to nudge or prompt a user 104A, 104B, 104N to modify a service request property and/or user preference. At operation 402, the service assignment system 102 accesses a transportation service request made by a user 104A, 104B, 104N.

At operation 404, the service assignment system 102 determines if the requested transportation service is suitable for execution by an AV, such as one of the AVs 110A, 110B, 110N, 114A, 114B, 114N. This may include, for example, accessing user preference data 132 to determine user preferences associated with the user 104A, 104B, 104N as well as considering the request properties of the transportation service request.

It will be appreciated that various different user preferences and/or request properties may be relevant to whether a requested transportation service is suitable for execution by an AV. As described herein, the user's preference for the location to pick up payload from a transportation service may be relevant. For example, as described herein, if the user's preference is to have payload dropped off at the door, the transportation service might not be suitable for AV execution. On the other hand, if the user's preference is to meet the vehicle at a curb to pick up payload at a service end location, then the requested transportation service is more likely to be suitable for AV execution. Also, in some examples, the user's preference for walking distance to meet the vehicle at the service start location may also be relevant to whether the transportation service is suitable for AV execution. Similarly, a user's preference for pickup and/or drop-off locations may be relevant to whether the transportation service is suitable for AV execution. For example, if the user's preferred pickup and/or drop-off location is in an area inaccessible to an AV, the transportation service may not be suitable for AV execution.

In some examples, the user's preference relating to a particular ride-sharing level of service may be relevant to whether the requested transportation service is suitable for AV execution. For example, if the user's preference is for a reserved ride, depending on implementation, a reserved ride may be more or less suitable for AV execution. Also, in another example, a “white glove” or similar service may be offered. According to a white glove or similar service, human operator may provide additional services to the user such as, for example, fighting payload directly to a door or other user-requested location, escorting the user to and/or from a vehicle, and/or the like. If a user's preference is for a white glove or similar service, the transportation service may not be suitable for AV execution.

In some examples, the user's payment preferences are relevant to whether a requested transportation service is suitable for execution by an AV. For example, some AV's may lack equipment for receiving cash payments. As a result, if the user's preference is to pay in cash, the transportation service may not be suitable for AV execution whereas if the user's preference is to pay by card, the transportation service may be suitable for AV execution.

Also, various request properties may affect whether a particular transportation service is suitable for AV execution. For example, one or more sets of AVs 110A, 110B, 110N, 114A, 114B, 114N may have a maximum payload capacity (e.g., weight, volume, and/or the like). A transportation service requesting transport of payload that exceeds the capacity of an AV may not be suitable for execution at the AV. Also, in some examples, a transportation service request to receive payload from a payload provider, such as a restaurant, that does not support loading the payload into an AV may not be suitable for AV execution.

If the requested transportation service is suitable for execution by an AV, the service assignment system 102 may proceed with the service assignment at operation 414 (e.g., proceed to operation 304 of the process flow 300). In some examples, the service assignment system 102 executes optional operation 406 if the requested transportation service is suitable for execution by an AV. At optional operation 406, the service assignment system 102 prompts the user 104A, 104B, 104N to confirm that the requested transportation service could possibly be assigned to an AV. In response, the user 104A, 104B, 104N may confirm that the requested transportation service may be executed by an AV or request that the transportation service not be executed by an AV. In this way, a requesting user 104A, 104B, 104N who is not aware that a requested transportation service is suitable for execution by an AV may not be surprised by the assigning of an AV, lessening the risk of the user 104A, 104B, 104N declining to accept an AV.

If the requested transportation service is not suitable for execution by an AV, the service assignment system 102, at operation 408, may prompt the user 104A, 104B, 104N to modify a user preference and/or service request property to make the requested transportation service suitable for execution by an AV. The prompt may be made, for example, via the user interface 122. The request may identify one or more changes to user preferences and/or request properties that would make the requested transportation service suitable for execution by an AV.

After having prompted the user 104A, 104B, 104N to modify a user preference at operation 408, the service assignment system 102 may determine at operation 410 whether the user 104A, 104B, 104N has modified the requested transportation service and/or a user preference to make the transportation service request suitable for AV execution. For example, the user 104A, 104B, 104N may provide a modification that changes a property of the request, a modification that changes a value of a user preference, and/or a modification that changes a user preference to a conditional user preference, as described herein. If no modification is received and/or a received modification does not render the requested transportation service suitable for AV execution, the service assignment system 102 may continue with the assignment of a vehicle to the requested transportation service at operation 414.

If the user has provided a modification that makes the requested transportation service suitable for AV execution, the service assignment system 102 may modify the corresponding user preferences and/or request properties at operation 412 and proceed with assignment of a vehicle at operation 414. In examples in which user preferences are modified, the service assignment system 102 may optionally modify user preference data 132 for the user 104A, 104B, 104N so that the indicated changes carry forward to the next requests from that user 104A, 104B, 104N.

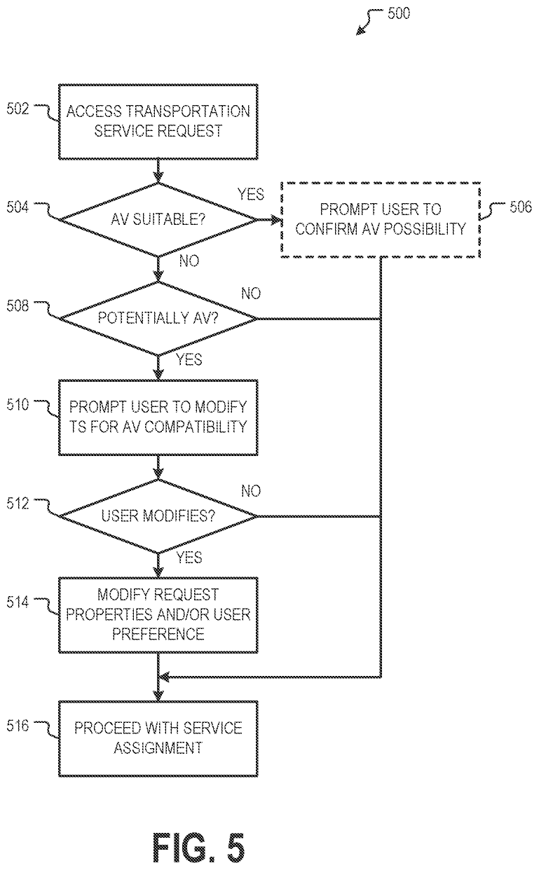

FIG. 5 is a flowchart showing another example of a process flow 500 that may be executed by the service assignment system 102 (e.g., the transportation service selection engine 124 thereof) to nudge or prompt a user 104A, 104B, 104N to modify a service request property and/or user preference. At operation 502, the service assignment system 102 accesses a transportation service request made by a user 104A, 104B, 104N.

At operation 504, the service assignment system 102 determines if the requested transportation service is suitable for execution by an AV, such as one of the AVs 110A, 110B, 110N, 114A, 114B, 114N. This may include, for example, accessing user preference data 132 to determine user preferences associated with the user 104A, 104B, 104N as well as considering the request properties of the transportation service request. If the requested transportation service is suitable for execution by an AV, the service assignment system 102 may proceed with the service assignment at operation 516 (e.g., proceed to operation 304 of the process flow 300). In some examples, the service assignment system 102 executes optional operation 506 to prompt the user 104A, 104B, 104N to confirm the possibility that the requested transportation service will be executed by an AV.

If the requested transportation service is not suitable for execution by an AV, the service assignment system 102 may determine, at operation 508, whether the requested transportation service could potentially be suitable for AV execution. For example, it may not be possible and/or desirable to modify some requested transportation services to be suitable for AV execution. For example, if the service start and/or service end location for a requested transportation service is not in a geographic area that can be served by an AV, the transportation service may not be modifiable to be suitable for AV execution.

Also, in some examples, there may be certain user preferences and/or request properties that the service assignment system 102 is programmed not to prompt the user 104A, 104B, 104N to modify. If a requested transportation service has such a request property and/or the requesting user 104A, 104B, 104N has such a user preference, the service assignment system 102 may determine that the requested transportation service is not potentially executable by an AV. For example, if a requested transportation service is not suitable for AV execution because the requested payload is too large, heavy, or otherwise not suitable for an AV, the service assignment system 102 may not be potentially AV executable. Also, in some examples, if a requested transportation service is not suitable for AV execution because the selected payload provider is not equipped to load an AV, the service assignment system 102 may determine that the requested transportation service is not potentially suitable for AV execution. If a requested transportation service is not potentially, AV executable, the service assignment system 102 may proceed with the assignment of a vehicle to the requested transportation service at operation 516.

If the requested transportation service is not suitable for AV execution (operation 504) and is potentially suitable for AV execution (operation 508), the service assignment system 102 may prompt the user 104A, 104B, 104N to modify a user preference and/or request property to make the requested transportation service suitable for execution by an AV at operation 510. The prompt may be made, for example, via the user interface 122. The request may identify one or more changes to user preferences and/or request properties that would make the requested transportation service suitable for execution by an AV.

After having prompted the user 104A, 104B, 104N to modify a user preference at operation 510, the service assignment system 102 may determine at operation 514 whether the user 104A, 104B, 104N has modified the requested transportation service and/or a user preference to make the transportation service request suitable for AV execution. For example, the user 104A, 104B, 104N may provide a modification that changes a property of the request, a modification that changes a value of a user preference, and/or a modification that changes a user preference to a conditional user preference, as described herein. If no modification is received and/or a received modification does not render the requested transportation service suitable for AV execution, the service assignment system 102 may continue with the assignment of a vehicle to the requested transportation service at operation 516.

If the user has provided a modification that makes the requested transportation service suitable for AV execution, the service assignment system 102 may modify the corresponding user preferences and/or request properties at operation 512 and proceed with assignment of a vehicle at operation 516.

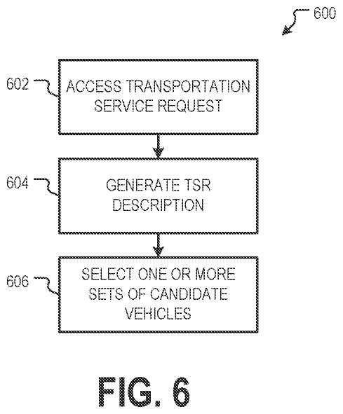

FIG. 6 is a flowchart showing one example of a process flow 600 that may be executed by the service assignment system 102 (e.g., the transportation service selection engine 124 thereof) to filter the mixed fleet of vehicles to determine a set of one or more candidate vehicles. For example, the process flow 600 shows one example way that the service assignment system 102 may execute the operation 304 of the process flow 300.

At operation 602, the service assignment system 102 accesses a transportation service request. At operation 604, the service assignment system 102 generates a description of the requested transportation service. The description may be based on the transportation service request as well as on the user preference data 132 of the requesting user 104A, 104B, 104N. For example, the description may indicate the service start location, the service end location, details of the requested payload, and the like. The description may also indicate user preferences such as, for example, where the user prefers to meet the payload or have it dropped off, and/or the like.

At operation 606, the service assignment system 102 selects a set of one or more candidate vehicles for the requested transportation service based on the transportation service description. For example, the set of one or more candidate vehicles may include vehicles that are capable of executing the requested transportation service. If the requested transportation service is suitable for AV execution, the set of one or more candidate vehicles may include one or more AVs 110A, 110B, 110N, 114A, 114B, 114N as well as one or more human-driven vehicles 118A, 118B, 118N. The service assignment system 102 may select from the candidate vehicles one or more vehicles to which the transportation service may be offered, for example, as described herein at operation 306.

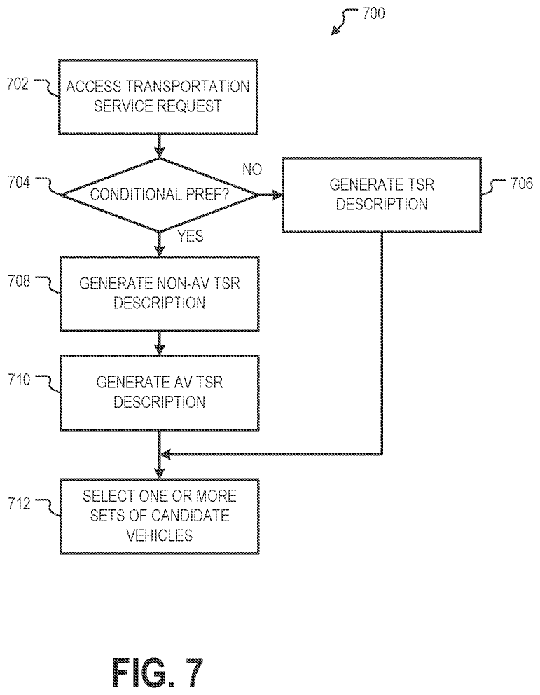

FIG. 7 is a flowchart showing one example of a process flow 700 that may be executed by the service assignment system 102 (e.g., the transportation service selection engine 124 thereof) to filter the mixed fleet of vehicles to determine a set of one or more candidate vehicles using at least one conditional user preference. For example, the process flow 700 shows another example way that the service assignment system 102 may execute the operation 304 of the process flow 300.

At operation 702, the service assignment system 102 accesses a transportation service request. At operation 704, the service assignment system 102 determines whether the user 104A, 104B, 104N making the transportation service request is associated with any conditional user preferences, such as described by conditional preference data 130. As described herein, a conditional user preference has an AV state that may be compatible with AV execution and a non-AV state that may not be compatible with AV execution.

If the requesting user 104A, 104B, 104N is not associated with any conditional user preferences, the service assignment system 102 may generate a description of the transportation service request at operation 706 and proceed to operation 712. In some examples, the determining at operation 704 may also determine whether a conditional preference can render a transportation service request suitable for AV execution. For example, if a requesting user 104A, 104B, 104N has a conditional user preference, but using the AV state of the conditional user preference would not make the requested transportation service suitable for AV execution, the service assignment system 102 may proceed to operations 706 and 712.

If the requesting user 104A, 104B, 104N is associated with a conditional user preference, the service assignment system 102 may generate a non-AV description of the transportation service request at operation 708 and may generate an AV description of the transportation service request at operation 710. The AV description of the transportation service request may be a description that is based on the AV state of the conditional user preference or user preferences. The non-AV description of the transportation service request may be a description that is based on the non-AV state of the conditional user preference.

Consider a conditional user preference related to where the user 104A, 104B, 104N would like to pick up their payload. An example user 104A, 104B, 104N may have a conditional user preference indicating that they will pick up their payload at the curb if an AV is delivering the payload and would like to have it dropped off at the door if a human-driven vehicle is delivering the payload. In this example, the non-AV description may indicate that the payload is to be dropped off at the door while the AV description may indicate that the payload is to be picked up at the curb.

At operation 712, the service assignment system 102 selects one or more sets of candidate vehicles for the requested transportation service based on the descriptions. If a single transportation service description is generated at operation 706, the service assignment system 102 may select a set of candidate vehicles that can execute a requested transportation service according to the single transportation service description. In examples including a non-AV transportation service description and an AV transportation service description, the selected vehicles may include AVs that are suitable to execute the transportation service according to the AV transportation service description as well as vehicles that are suitable to execute the transportation service according to the non-AV transportation service description.

### EXAMPLES

Example 1 is a system for managing a mixed fleet of vehicles to execute transportation services, the system comprising: at least one processor programmed to perform operations comprising: accessing first transportation service request data describing a first transportation service requested by a first user via a first user computing device; determining that the first transportation service is not suitable for execution by at least one of a plurality of autonomous vehicles (AV) of the mixed fleet of vehicles, the mixed fleet of vehicles comprising a plurality of human-driven vehicles and the plurality of AVs; prompting the first user via the first user computing device to make a modification to the first transportation service to make it suitable for execution by the at least one of the plurality of AVs; selecting a first vehicle of the mixed fleet of vehicles to execute the first transportation service based on the first transportation service request data and the modification to the first transportation service; and instructing the first vehicle to begin executing the first transportation service.

In Example 2, the subject matter of Example 1 optionally includes wherein the first vehicle is the at least one of the plurality of AVs.

In Example 3, the subject matter of any one or more of Examples 1-2 optionally includes the determining that the first transportation service is suitable for execution by at least one of the plurality of AVs being based at least in part on first user preference data describing a first user preference of the first user.

In Example 4, the subject matter of any one or more of Examples 1-3 optionally includes the modification to the first transportation service comprising a modification to at least one user preference of the first user.

In Example 5, the subject matter of any one or more of Examples 1-4 optionally includes the modification to the first transportation service comprising a modification to the first transportation service request data.

In Example 6, the subject matter of any one or more of Examples 1-5 optionally includes the operations further comprising, before prompting the first user to make the modification to the first transportation service, determining that the first transportation service can be modified to make it suitable for execution by the at least one AV, wherein the prompting the first user to make the modification to the first transportation service comprises prompting the first user to make a modification to the first transportation service.

In Example 7, the subject matter of any one or more of Examples 1-6 optionally includes wherein: the modification to the first transportation service comprises a conditional user preference for the first user, the conditional user preference having an AV state and a non-AV state; and the instructing the first vehicle to begin executing the first transportation service comprises: instructing, if the first vehicle is an AV, to begin executing the first transportation service using the AV state; and instructing, if the first vehicle is not an AV, to begin executing the first transportation service using the non-AV state.

In Example 8, the subject matter of any one or more of Examples 1-7 optionally includes the operations further comprising excluding the at least one AV from being eligible to execute the first transportation service if the first user does not make the modification.

In Example 9, the subject matter of any one or more of Examples 1-8 optionally includes wherein instructing the first vehicle to begin executing the first transportation service comprises instructing a human or third-party system associated with the first vehicle to begin executing the first transportation service using the first vehicle.

In Example 10, the subject matter of any one or more of Examples 1-9 optionally includes the operations further comprising: accessing second transportation service request data describing a second transportation service requested by a second user via a second user computing device; determining that the second transportation service is suitable for execution by at least one of the plurality of AVs of the mixed fleet of vehicles; prompting the second user to confirm acceptance of an AV for the second transportation service; receiving, from the second user, a confirmation in response to the prompting; and instructing at least one of the plurality of AVs to execute the second transportation service.

In Example 11, the subject matter of any one or more of Examples 1-optionally includes the operations further comprising: accessing user preference data describing preferences of the first user, the user preference data indicating a conditional user preference having an autonomous vehicle (AV) state and a non-AV state; generating an AV transportation service description for the first transportation service using the AV state of the conditional user preference; selecting a plurality of candidate AVs from the mixed fleet of vehicles using the AV transportation service description; generating a non-AV transportation service description for the first transportation service using the non-AV state of the conditional user preference; selecting a plurality of candidate human-driven vehicles from the mixed fleet of vehicles; and selecting the first vehicle from the plurality of candidate AVs or from the plurality of human-driven vehicles, the first vehicle being an AV.

Example 12 is a method of managing a mixed fleet of vehicles to execute transportation services, the method comprising: accessing first transportation service request data describing a first transportation service requested by a user via a user computing device; determining that the first transportation service is not suitable for execution by at least one of a plurality of autonomous vehicles (AV) of the mixed fleet of vehicles, the mixed fleet of vehicles comprising a plurality of human-driven vehicles and the plurality of AVs; prompting the user via the user computing device to make a modification to the first transportation service to make it suitable for execution by the at least one of the plurality of AVs; selecting a first vehicle of the mixed fleet of vehicles to execute the first transportation service based on the first transportation service request data and the modification to the first transportation service; and instructing the first vehicle to begin executing the first transportation service.

In Example 13, the subject matter of Example 12 optionally includes wherein the first vehicle is the at least one of the plurality of AVs.

In Example 14, the subject matter of any one or more of Examples 12-13 optionally includes the determining that the first transportation service is suitable for execution by at least one of the plurality of AVs being based at least in part on user preference data describing a user preference of the user.

In Example 15, the subject matter of any one or more of Examples 12-14 optionally includes the modification to the first transportation service comprising a modification to at least one user preference of the user.

In Example 16, the subject matter of any one or more of Examples 12-optionally includes the modification to the first transportation service comprising a modification to the first transportation service request data.

In Example 17, the subject matter of any one or more of Examples 12-16 optionally includes before prompting the user computing device to make the modification to the first transportation service, determining that the first transportation service can be modified to make it suitable for execution by the at least one AV, wherein the prompting the user via a user computing device to make a modification to the first transportation service comprises prompting the user via a user computing device to make a modification to the first transportation service.

In Example 18, the subject matter of any one or more of Examples 12-17 optionally includes wherein: the modification to the first transportation service comprises a conditional user preference for the user, the conditional user preference having an AV state and a non-AV state; and the instructing the first vehicle to begin executing the first transportation service comprises: instructing, if the first vehicle is an AV, to begin executing the first transportation service using the AV state; and instructing, if the first vehicle is not an AV, to begin executing the first transportation service using the non-AV state.

In Example 19, the subject matter of any one or more of Examples 12-18 optionally includes excluding the at least one AV from being eligible to execute the first transportation service if the user does not make the modification.

Example 20 is a method of managing a mixed fleet of vehicles to execute transportation services, the method comprising: accessing user preference data describing preferences of a user, the user preference data indicating a conditional user preference having an autonomous vehicle (AV) state and a non-AV state; accessing first transportation service request data describing a first transportation service requested by the user via a user computing device; generating an AV transportation service description for the first transportation service using the AV state of the conditional user preference; selecting a plurality of candidate AVs from the mixed fleet of vehicles using the AV transportation service description; generating a non-AV transportation service description for the first transportation service using the non-AV state of the conditional user preference; selecting a plurality of candidate human-driven vehicles from the mixed fleet of vehicles; selecting a first vehicle from the plurality of candidate AVs or from the plurality of human-driven vehicles, the first vehicle being an AV; and instructing the first vehicle to begin executing the first transportation service.

FIG. 8 is a block diagram 800 showing one example of a software architecture 802 for a computing device. The software architecture 802 may be used in conjunction with various hardware architectures, for example, as described herein. FIG. 8 is merely a non-limiting example of a software architecture 802, and many other architectures may be implemented to facilitate the functionality described herein. A representative hardware layer 804 is illustrated and can represent, for example, any of the above-referenced computing devices. In some examples, the hardware layer 804 may be implemented according to a hardware architecture, such as the hardware architecture 900 of FIG. 9 and/or the software architecture 802 of FIG. 8.

The representative hardware layer 804 comprises one or more processing units 806 having associated executable instructions 808. The executable instructions 808 represent the executable instructions of the software architecture 802, including implementation of the methods, modules, components, and so forth of FIGS. 1-7. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the hardware architecture 900.

In the example architecture of FIG. 8, the software architecture 802 may be conceptualized as a stack of layers where each layer provides particular functionality. For example, the software architecture 802 may include layers such as an operating system 814, libraries 816, middleware layer 818, applications 820, and a presentation layer 844. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature, and not all software architectures have all layers. For example, some mobile or special-purpose operating systems may not provide a middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of a hardware or software interrupt and, in response, cause the software architecture 802 to pause its current processing and execute an interrupt service routine (ISR) when an interrupt is received. The ISR may generate an alert.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), WiFi® drivers, near-field communication (NFC) drivers, audio drivers, power management drivers, and so forth depending on the hardware configuration.

The libraries 816 may provide a common infrastructure that may be used by the applications 820 and/or other components and/or layers. The libraries 816 typically provide functionality that allows other software modules to perform tasks in an easier fashion than by interfacing directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The middleware layer 818 (also sometimes referred to as frameworks) may provide a higher-level common infrastructure that may be used by the applications 820 and/or other software components/modules. For example, the middleware layer 818 may provide various graphical user interface (GUI) functions, high-level resource management, high-level location services, and so forth. The middleware layer 818 may provide a broad spectrum of other APIs that may be used by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. The third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 842 may invoke the API calls 824 provided by the mobile operating system such as the operating system 814 to facilitate functionality described herein.

The applications 820 may use built-in operating system functions (e.g., kernel 828, services 830, and/or drivers 832), libraries (e.g., system libraries 834, API libraries 836, and other libraries 838), or middleware layer 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 8, this is illustrated by a virtual machine 848. A virtual machine creates a software environment where applications/modules can execute as if they were executing on a hardware computing device. The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

FIG. 9 is a block diagram illustrating a hardware architecture 900 of an example computing device, within which a set or sequence of instructions can be executed to cause a machine to perform examples of any one of the methodologies discussed herein. The hardware architecture 900 describes a computing device for executing the vehicle autonomy system, described herein.

The hardware architecture 900 may operate as a standalone device or may be connected (e.g., networked) to other machines. In a networked deployment, the hardware architecture 900 may operate in the capacity of either a server or a client machine in server-client network environments, or it may act as a peer machine in peer-to-peer (or distributed) network environments. The hardware architecture 900 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example hardware architecture 900 includes a processor unit 902 comprising at least one processor (e.g., a central processing unit (CPU), a graphics processing unit (GPU), or both, processor cores, compute nodes). The hardware architecture 900 may further comprise a main memory 904 and a static memory 906, which communicate with each other via a link 908 (e.g., a bus). The hardware architecture 900 can further include a video display unit 910, an input device 912 (e.g., a keyboard), and a UI navigation device 914 (e.g., a mouse). In some examples, the video display unit 910, input device 912, and UI navigation device 914 are incorporated into a touchscreen display. The hardware architecture 900 may additionally include a storage device 916 (e.g., a drive unit), a signal generation device 918 (e.g., a speaker), a network interface device 920, and one or more sensors (not shown), such as a Global Positioning System (GPS) sensor, compass, accelerometer, or other sensor.

In some examples, the processor unit 902 or another suitable hardware component may support a hardware interrupt. In response to a hardware interrupt, the processor unit 902 may pause its processing and execute an ISR, for example, as described herein.

The storage device 916 includes a machine-readable medium 922 on which is stored one or more sets of data structures and instructions 924 (e.g., software) embodying or used by any one or more of the methodologies or functions described herein. The instructions 924 can also reside, completely or at least partially, within the main memory 904, within the static memory 906, and/or within the processor unit 902 during execution thereof by the hardware architecture 900, with the main memory 904, the static memory 906, and the processor unit 902 also constituting machine-readable media.

### Executable Instructions and Machine-Storage Medium

The various memories (i.e., main memory 904, static memory 906, and/or memory of the processor unit(s) 902) and/or the storage device 916 may store one or more sets of instructions and data structures (e.g., the instructions 924) embodying or used by any one or more of the methodologies or functions described herein. These instructions, when executed by the processor unit(s) 902, cause various operations to implement the disclosed examples.

As used herein, the terms “machine-storage medium,” “device-storage medium,” and “computer-storage medium” (referred to collectively as “machine-storage medium”) mean the same thing and may be used interchangeably. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium” and “device-readable medium” mean the same thing and may be used interchangeably in this disclosure. The terms are defined to include both non-transitory machine-storage media and signal media. Thus, the terms include both storage devices/media and carrier waves/modulated data signals.

The instructions 924 can further be transmitted or received over a communications network 926 using a transmission medium via the network interface device 920 using any one of a number of well-known transfer protocols (e.g., Hypertext Transfer Protocol (HTTP)). Examples of communication networks include a local area network (LAN), a wide area network (WAN), the Internet, mobile telephone networks, plain old telephone service (POTS) networks, and wireless data networks (e.g., Wi-Fi, 3G, 4G Long-Term Evolution (LTE)/LTE-A, 5G, or WiMAX networks).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A system for managing a mixed fleet of vehicles to execute transportation services, the system comprising:
at least one processor programmed to perform operations comprising:
accessing first transportation service request data describing a first transportation service requested by a first user via a first user computing device;
determining that the first transportation service is not suitable for execution by at least one of a plurality of autonomous vehicles (AV) of the mixed fleet of vehicles, the mixed fleet of vehicles comprising a plurality of human-driven vehicles and the plurality of AVs;
prompting the first user via the first user computing device to make a modification to the first transportation service to make it suitable for execution by the at least one of the plurality of AVs;
selecting a first vehicle of the mixed fleet of vehicles to execute the first transportation service based on the first transportation service request data and the modification to the first transportation service; and
instructing the first vehicle to begin executing the first transportation service.

2. The system of claim 1, wherein the first vehicle is the at least one of the plurality of AVs.

3. The system of claim 1, the determining that the first transportation service is suitable for execution by at least one of the plurality of AVs being based at least in part on first user preference data describing a first user preference of the first user.

4. The system of claim 1, the modification to the first transportation service comprising a modification to at least one user preference of the first user.

5. The system of claim 1, the modification to the first transportation service comprising a modification to the first transportation service request data.

6. The system of claim 1, the operations further comprising, before prompting the first user to make the modification to the first transportation service, determining that the first transportation service can be modified to make it suitable for execution by the at least one AV, wherein the prompting the first user to make the modification to the first transportation service comprises prompting the first user to make a modification to the first transportation service.

7. The system of claim 1, wherein:
the modification to the first transportation service comprises a conditional user preference for the first user, the conditional user preference having an AV state and a non-AV state; and
the instructing the first vehicle to begin executing the first transportation service comprises:
instructing, if the first vehicle is an AV, to begin executing the first transportation service using the AV state; and
instructing, if the first vehicle is not an AV, to begin executing the first transportation service using the non-AV state.

8. The system of claim 1, the operations further comprising excluding the at least one AV from being eligible to execute the first transportation service if the first user does not make the modification.

9. The system of claim 1, wherein instructing the first vehicle to begin executing the first transportation service comprises instructing a human or third-party system associated with the first vehicle to begin executing the first transportation service using the first vehicle.

10. The system of claim 1, the operations further comprising:
accessing second transportation service request data describing a second transportation service requested by a second user via a second user computing device;
determining that the second transportation service is suitable for execution by at least one of the plurality of AVs of the mixed fleet of vehicles;
prompting the second user to confirm acceptance of an AV for the second transportation service;
receiving, from the second user, a confirmation in response to the prompting; and
instructing at least one of the plurality of AVs to execute the second transportation service.

11. The system of claim 1, the operations further comprising:
accessing user preference data describing preferences of the first user, the user preference data indicating a conditional user preference having an autonomous vehicle (AV) state and a non-AV state;
generating an AV transportation service description for the first transportation service using the AV state of the conditional user preference;
selecting a plurality of candidate AVs from the mixed fleet of vehicles using the AV transportation service description;
generating a non-AV transportation service description for the first transportation service using the non-AV state of the conditional user preference;
selecting a plurality of candidate human-driven vehicles from the mixed fleet of vehicles; and
selecting the first vehicle from the plurality of candidate AVs or from the plurality of human-driven vehicles, the first vehicle being an AV.

12. A method of managing a mixed fleet of vehicles to execute transportation services, the method comprising:
accessing first transportation service request data describing a first transportation service requested by a user via a user computing device;
determining that the first transportation service is not suitable for execution by at least one of a plurality of autonomous vehicles (AV) of the mixed fleet of vehicles, the mixed fleet of vehicles comprising a plurality of human-driven vehicles and the plurality of AVs;
prompting the user via the user computing device to make a modification to the first transportation service to make it suitable for execution by the at least one of the plurality of AVs;
selecting a first vehicle of the mixed fleet of vehicles to execute the first transportation service based on the first transportation service request data and the modification to the first transportation service; and
instructing the first vehicle to begin executing the first transportation service.

13. The method of claim 12, wherein the first vehicle is the at least one of the plurality of AVs.

14. The method of claim 12, the determining that the first transportation service is suitable for execution by at least one of the plurality of AVs being based at least in part on user preference data describing a user preference of the user.

15. The method of claim 12, the modification to the first transportation service comprising a modification to at least one user preference of the user.

16. The method of claim 12, the modification to the first transportation service comprising a modification to the first transportation service request data.

17. The method of claim 12, further comprising, before prompting the user computing device to make the modification to the first transportation service, determining that the first transportation service can be modified to make it suitable for execution by the at least one AV, wherein the prompting the user via a user computing device to make a modification to the first transportation service comprises prompting the user via a user computing device to make a modification to the first transportation service.

18. The method of claim 12, wherein:
the modification to the first transportation service comprises a conditional user preference for the user, the conditional user preference having an AV state and a non-AV state; and
the instructing the first vehicle to begin executing the first transportation service comprises:
instructing, if the first vehicle is an AV, to begin executing the first transportation service using the AV state; and
instructing, if the first vehicle is not an AV, to begin executing the first transportation service using the non-AV state.

19. The method of claim 12, further comprising excluding the at least one AV from being eligible to execute the first transportation service if the user does not make the modification.

20. A method of managing a mixed fleet of vehicles to execute transportation services, the method comprising:
accessing user preference data describing preferences of a user, the user preference data indicating a conditional user preference having an autonomous vehicle (AV) state and a non-AV state;
accessing first transportation service request data describing a first transportation service requested by the user via a user computing device;
generating an AV transportation service description for the first transportation service using the AV state of the conditional user preference;
selecting a plurality of candidate AVs from the mixed fleet of vehicles using the AV transportation service description;
generating a non-AV transportation service description for the first transportation service using the non-AV state of the conditional user preference;
selecting a plurality of candidate human-driven vehicles from the mixed fleet of vehicles;
selecting a first vehicle from the plurality of candidate AVs or from the plurality of human-driven vehicles, the first vehicle being an AV; and
instructing the first vehicle to begin executing the first transportation service.
